(19) United States
(12) Patent Application Publication
(10) Pub. No.: US 2025/0005659 A1
(43) Pub. Date: Jan. 2, 2025

(54) EMBEDDING CREDIT-BASED SYSTEMS IN EXISTING NON-CREDIT-BASED SYSTEMS TO GENERATE CREDIT TRANSACTIONS FROM NON-CREDIT TRANSACTIONS

(71) Applicant: Marqeta, Inc., Oakland, CA (US)

(72) Inventors: Akhila Singaraju, Oakland, CA (US); Matt Sollie, Decatur, GA (US); Kevin C. Issadore, Berkeley, CA (US); Calley Barton, San Anselmo, CA (US); Melissa Stoller, San Francisco, CA (US); Zachary Thomsen-Gray, Berkeley, CA (US)

(21) Appl. No.: 18/346,035

(22) Filed: Jun. 30, 2023

(51) Int. Cl. G06Q 40/03; G06Q 20/10; G06Q 20/40; G06Q 40/02

(52) U.S. Cl. CPC G06Q 40/03; G06Q 20/108; G06Q 20/4037; G06Q 40/02

(57) ABSTRACT

This disclosure relates to a credit integration system that efficiently and seamlessly embeds credit-based systems into non-credit-based systems. For instance, the credit integration system provides an operational framework that enables functions and features of a credit-based system to be embedded into the existing workflow of non-credit-based systems. In addition to technical benefits, such as reducing redundant system portions by creatively integrating portions of a credit-based system into different existing non-credit-based systems, the credit integration system allows users to capture benefits from the credit-based system without changing their current behaviors with their existing non-credit-based systems. For example, the credit integration system allows users to build a credit history by performing non-credit transactions using their payment card tied to a non-credit-based system.

### BACKGROUND

In recent years, both hardware and software platforms have made notable progress in enhancing the management of digital deposits, user accounts, and other services provided by financial institutions. One example is the use of a network of computing systems that allows users to manage their stored digital deposits within their bank or user accounts, while also providing easy access to funds for transactions through an electronic payment card. However, to use credit for transactions, a separate network of computing systems is needed, along with a different electronic payment card. In many instances, these different networks inefficiently provide redundant features and functionalities. Additionally, these different systems often require users to manually create integration points between the two networks to allow them to communicate.

### BRIEF DESCRIPTION OF THE DRAWINGS

The detailed description provides one or more implementations with additional specificity and detail through the use of accompanying drawings, as briefly described below. Each included figure may be implemented according to one or more implementations in this disclosure.

FIG. 1 illustrates an example overview of implementing a credit integration system to generate credit-based transactions from non-credit-based transactions.

FIG. 2 illustrates an example system environment where a credit integration system is implemented to build user credit from non-credit-based transactions.

FIGS. 3A-3G illustrate an example process of the credit integration system generating credit-based transactions from non-credit-based transactions by embedding a credit-based system within a non-credit-based system.

FIG. 4 illustrates an example user interface process for selectively enabling features of the credit-based system.

FIG. 5 illustrates example user interfaces of the credit integration system providing credit indications to a cardholder based on the cardholder performing non-credit-based transactions.

FIG. 6 illustrates an example series of acts for generating user credit history based on non-credit-based transactions.

FIG. 7 illustrates example components included within a computer system.

### DETAILED DESCRIPTION

The present disclosure presents a credit integration system that efficiently and seamlessly embeds credit-based systems into non-credit-based systems. For instance, the credit integration system provides an operational framework that enables functions and features of a credit-based system to be embedded into the existing workflow of non-credit-based systems. In addition to technical benefits, such as reducing redundant system portions by creatively integrating portions of a credit-based system into different existing non-credit-based systems, the credit integration system allows users to capture benefits from the credit-based system without changing their current behaviors with their existing non-credit-based systems. For example, the credit integration system allows users to build a credit history by performing non-credit transactions using their payment card tied to a non-credit-based system.

Additionally, the credit integration system utilizes various techniques and models to efficiently and flexibly embed a credit-based system into non-credit-based systems in a manner that enables generation of credit for users within the framework of the non-credit-based system(s). For example, in some implementations, the credit integration system introduces new components, such as a credit borrowing account (e.g., a balance sheet account), a secured cardholder account, and a credit ledger to seamlessly integrate the credit-based system into a non-credit-based system. Further, the credit integration system employs an innovative framework to coordinate communications between the different systems and components to allow users to build a credit history from non-credit-based transactions without disrupting a user's current behaviors.

To briefly illustrate, in various implementations, the credit integration system migrates the target amount of funds from a user account to a secured user account that is not accessible by the user in response to detecting a user transacting for a target amount through a non-credit-based system (e.g., a prepaid or debit payment card). Additionally, the credit integration system generates a user credit transaction on behalf of the user for the target amount (e.g., a loan for the target amount) from a credit borrowing account managed by a credit-based computer system. Further, the credit integration system transfers the target amount from the secured user account to the credit borrowing account to cover the user credit transaction and generates a credit report of the user credit transaction.

As described in this document, the credit integration system delivers several technical benefits in terms of computing efficiency and flexibility compared to existing systems. Moreover, the credit integration system provides several practical applications that solve problems associated with implementing credit-based system within the framework of a non-credit-based system, resulting in several benefits.

As mentioned above, conventional systems often require separate networks for credit-based systems and non-credit-based systems. To illustrate, many banks, such as traditional banks and neobanks, assist their customers (i.e., users) in storing their deposits and spending these funds. Banks also provide electronic payment cards such as debit or prepaid cards to users, allowing them to directly access funds from their user accounts. This deposit-and-spend approach requires using a network of non-credit-based computing systems. If one of these banks also wants to provide credit borrowing services, the bank needs to use a separate network of credit-based computing systems, along with issuing new credit-based payment cards (e.g., a credit card) to users. While the two systems may appear connected to a user, the bank uses different networks with different frontends and backends to provide both services to users.

To elaborate, many conventional non-credit-based systems use a first set of frontend and backend networks to enable users to transact with merchant systems using the user's funds directly via a debit or prepaid payment card. Additionally, conventional credit-based systems use a different set of frontend and backend networks to facilitate user transactions with credit and borrowing funds, such as using credit cards, with the user having the option to pay back the funds later. As noted above, separate electronic payment cards (e.g., financial instruments) are needed to traditionally access both systems.

In contrast, the credit integration system embeds portions of the credit-based system into the non-credit-based system in an efficient, flexible, and seamless manner. By embedding a credit-based system into a non-credit-based system, the credit integration system efficiently eliminates several components of conventional credit systems. For example, the credit integration system removes the frontend network of the credit-based system. Additionally, the credit integration system also removes components of a conventional credit-based system needed to manage separate credit-based electronic payment cards, such as credit cards. Further, by combining portions of the two computing networks, the credit integration system improves computing efficiency in backend networks by reducing and streamlining the overall number of separate transactions that typically occur across both networks.

As another example, the credit integration system improves flexibility over conventional systems by allowing a credit-based system to agnostically integrate into different non-credit-based systems. For example, the credit integration system is able to integrate into most current non-credit-based systems with minimal additional functionality. For instance, the frontend networks of the non-credit-based systems remain largely unchanged and users can selectively enable using the features and benefits of the credit integration system without needing to get a new card or maintain a separate system for an additional credit-based electronic payment card. Indeed, the flexibility of the credit integration system allows it to be embedded within current non-credit-based systems without interruption or disputation to the non-credit-based systems.

As a further example, the credit integration system provides improved efficiency over conventional systems by allowing for user abstraction. To elaborate, because the credit integration system integrates seamlessly into the front end of the non-credit-based systems, the user (e.g., a cardholder) does not need to alter their habits with respect to their current non-credit-based electronic payment card. Instead, the credit integration system allows a cardholder to continue their transactions and purchases as they did before the credit integration system was enabled, and their transactions appear to have the same effect within the non-credit-based systems. However, the credit integration system seamlessly uses these transactions to generate credit-based transactions and build the user's credit history.

In this way, as described in this document, the credit integration system automatically converts a user's current actions with non-credit-based transactions into credit-building and credit-improving actions. Further, by embedding credit borrowing services within the traditional deposit-and-spend approach, the credit integration system improves a user's credit score while having little risk to the user or financial institutions while also improving the efficiency and flexibility of the computing systems needed to achieve these user benefits.

This disclosure uses several terms to describe the features and advantages of one or more implementations. While some terms are described here, these terms may be further defined below. Further, additional terms may be described below.

The term “non-credit-based computer system” (or simply “non-credit-based system”) refers to a system of computing devices and components that facilitates financial transactions without borrowing instruments. For instance, a non-credit-based system provides financial services based on deposited funds from users. In various implementations, a non-credit-based system includes computer networks and sub-systems, such as a frontend network for providing user interfaces and a backend network for managing transactions and communicating with other financial computing networks.

In various implementations, a non-credit-based system maintains user accounts that track current deposited funds and user spending. A “user account” refers to a bank or another type of account that stores funds that users have deposited for a specific purpose, such as saving or spending. A user account that is linked to a payment card may be referred to as a cardholder account. Additionally, the term “funds” refers to the user's financial resources available for a specific purpose, such as investment, saving, or spending. Often, a user account includes a “cash balance,” which refers to the amount of deposited funds a user has provided to a non-credit-based system for spending.

In some instances, a user account is linked to an electronic payment card. The terms “electronic payment card,” “payment card,” (or simply “card”) refers to a physical, electronic, or virtual credit, debit, or prepaid payment account or device that can be used to purchase goods or services (e.g., a plastic or virtual debit card, credit card, or prepaid card). In various implementations, a “non-credit-based payment card” refers to a card that transacts from a user's deposited funds rather than a user account that borrows money from another source. The term “credit-based payment card” refers to a card, such as a credit card, that transacts from borrowed funds or credit with the option to repay the loan later. Unless otherwise specified, the term payment card refers to a non-credit-based payment card.

Additionally, in this document, a user having a payment card is referred to as a “cardholder.” A cardholder may transact with a card with a merchant system. Card transactions for a target amount of funds (i.e., a particular amount of money) may result in a user transaction request being sent to a non-credit-based system for the target amount of funds. In this document, a “user transaction request” refers to a request for payment for a target amount of funds in response to a transaction made with a non-credit-based card.

In this document, the term “secured cardholder user account” (or simply “secured user account”) refers to an account credit on behalf of a user that is not directly accessible by the user. To clarify, the term “secured” indicates that the user cannot directly access funds in the account. For example, the secured user account holds funds in trust for the user for later repayment of borrowed funds on credit. In various implementations, a non-credit-based system manages the secured user account. In some implementations, another system manages the secured user account. The secured user account in this disclosure is not associated with a payment card.

The term “credit-based computer system” (or simply “credit-based system”) refers to a system of computing devices and components that facilitates credit-based financial interactions. In this document, “credit” and “credit-based” refers to funds that users borrow from a lender system or another lending source. Credit is often extended to users based on their ability to repay. In various implementations, the lender system provides a credit borrowing account from which users can borrow funds. For example, a “credit borrowing account” refers to a balance sheet account that tracks the assets, liabilities, and equity of users.

Additionally, in this document, a “user credit transaction” refers to an amount of credit that a user borrows from a lender system's credit borrowing account. For example, a user credit transaction includes a line of credit or another borrowing instrument that extends credit to a user. In this document, the credit integration system and/or a non-credit-based system interacts with a lender system to secure a user credit transaction for one or more users having user accounts with deposited funds.

A “user credit report” refers to a record of a user's or cardholder's credit history and/or borrowing behavior. In some instances, a user credit report includes details about loans, credit cards, and other forms of credit. In various implementations, user credit reports are utilized by financial institutions, lender systems, and/or credit card networks to assess creditworthiness and evaluate the risk of lending funds to users, businesses, or entities. In one or more instances, user credit reports are provided to the user and/or other parties authorized by the user.

The terms “payment network,” “payment card network,” and “card network computer” describe a secure and private network for communication of payment protocol messages between the computer systems of authorized parties, including banks, payment clearinghouses, merchants, card issuers, and card processors. The payment network is equipped with a system that processes payment card transactions as well as specialized networking components, computers, and software.

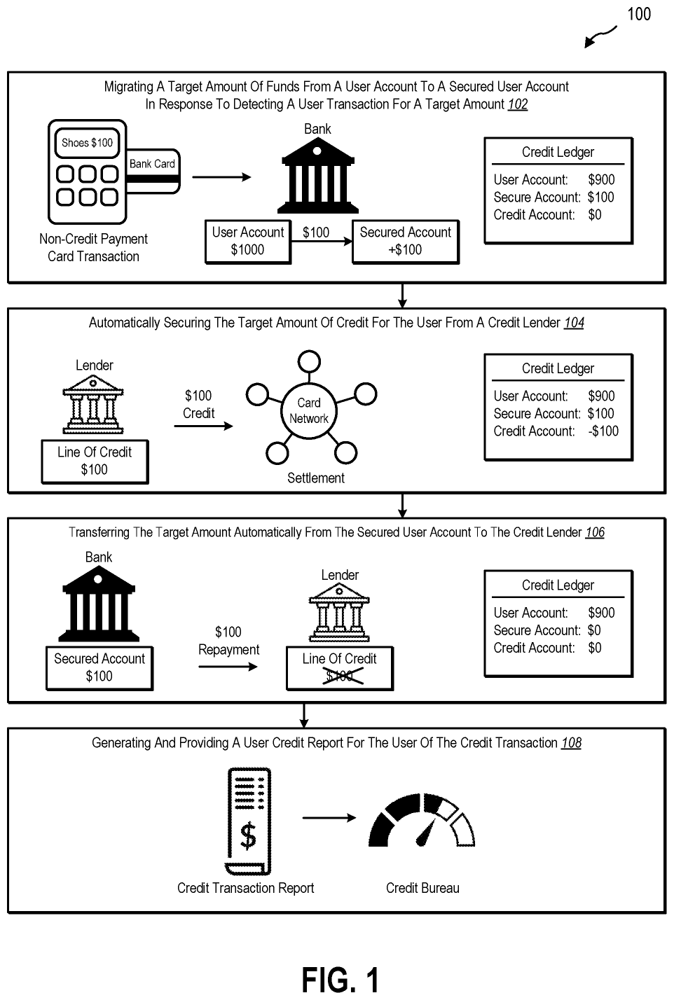

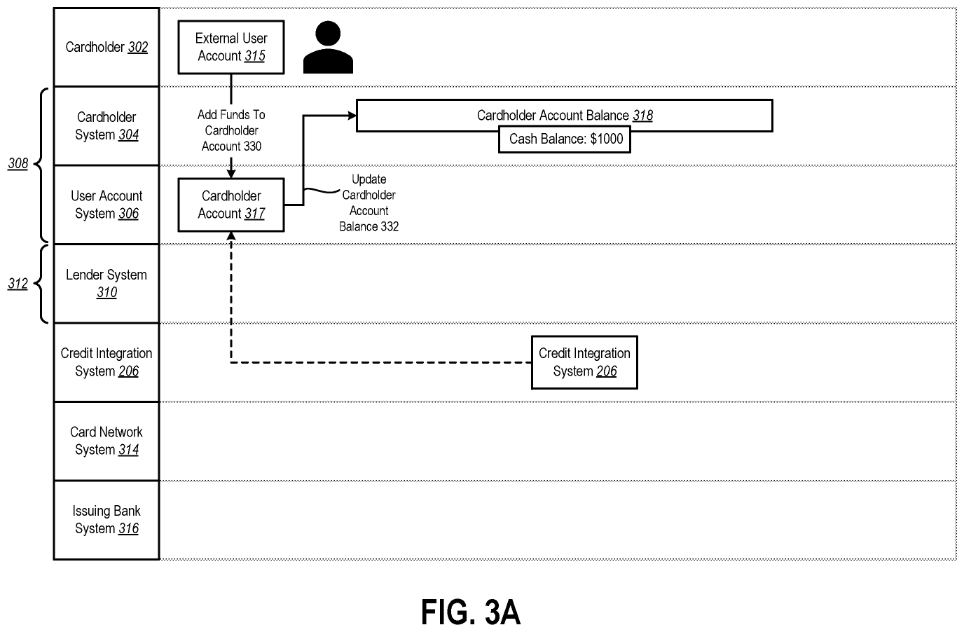

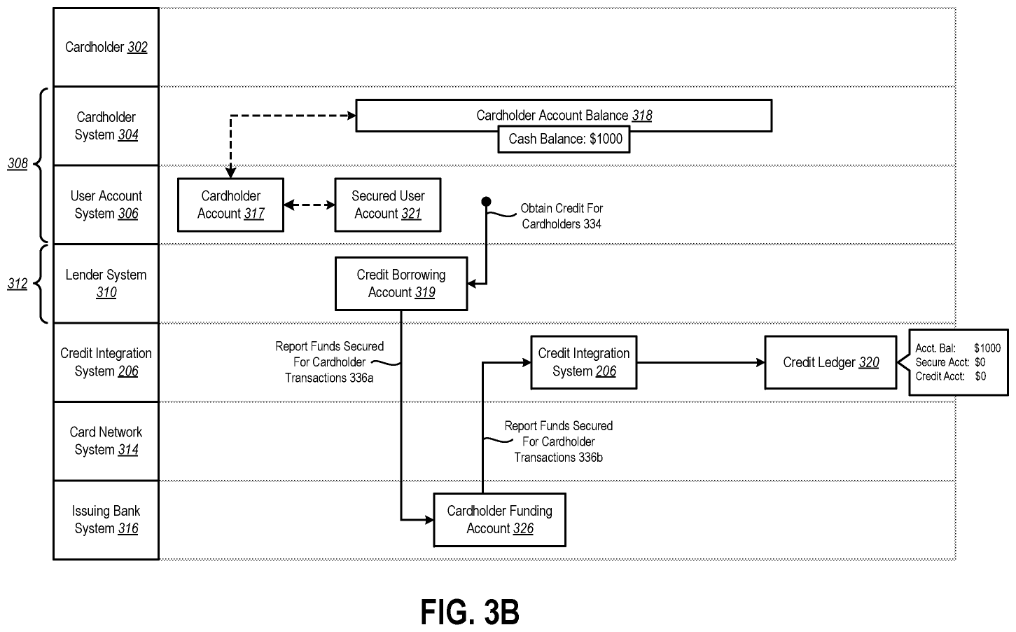

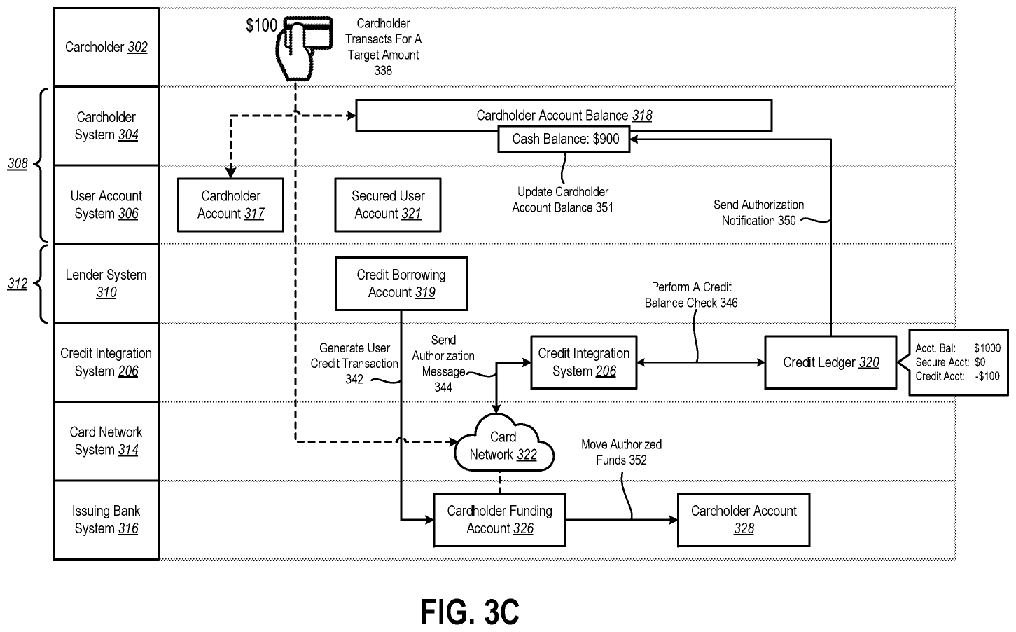

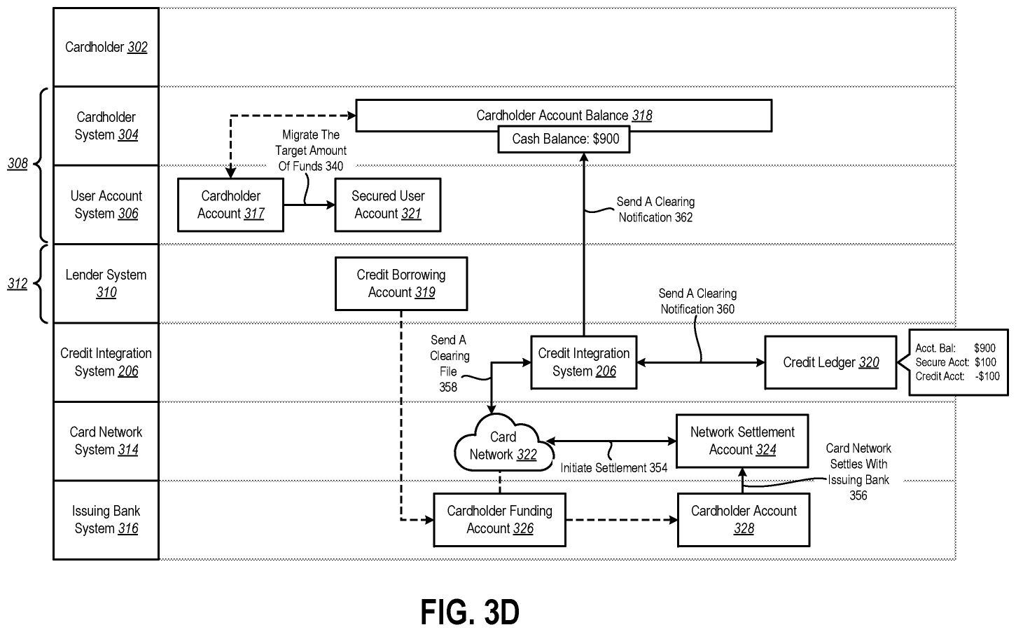

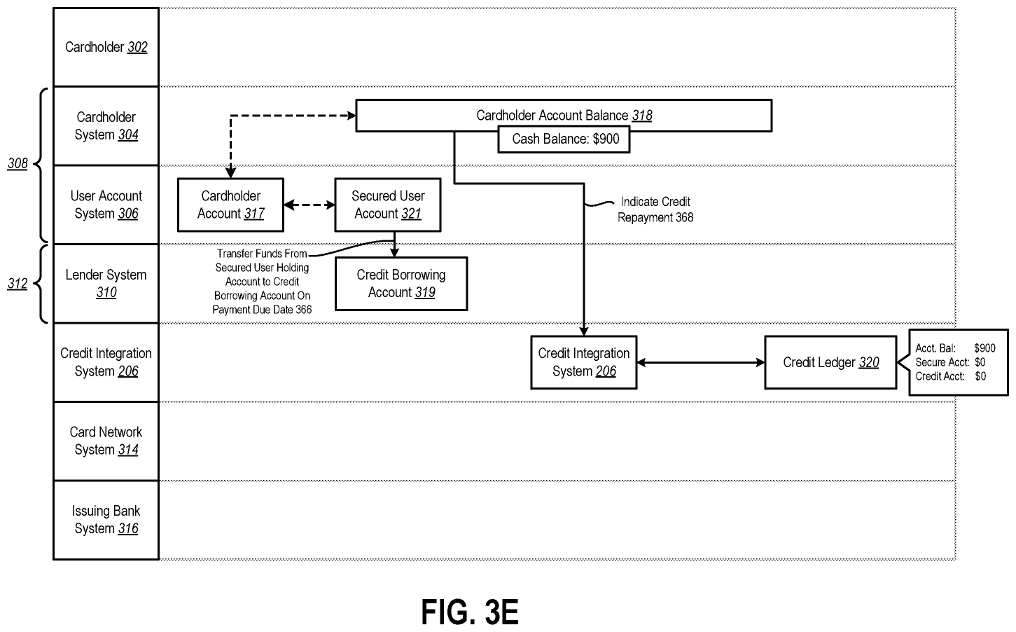

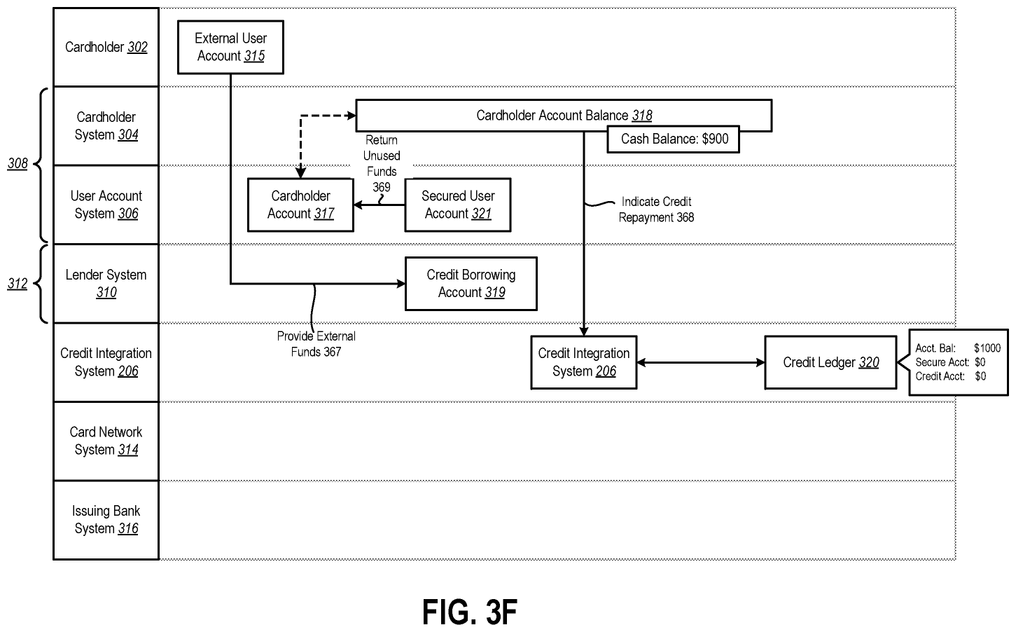

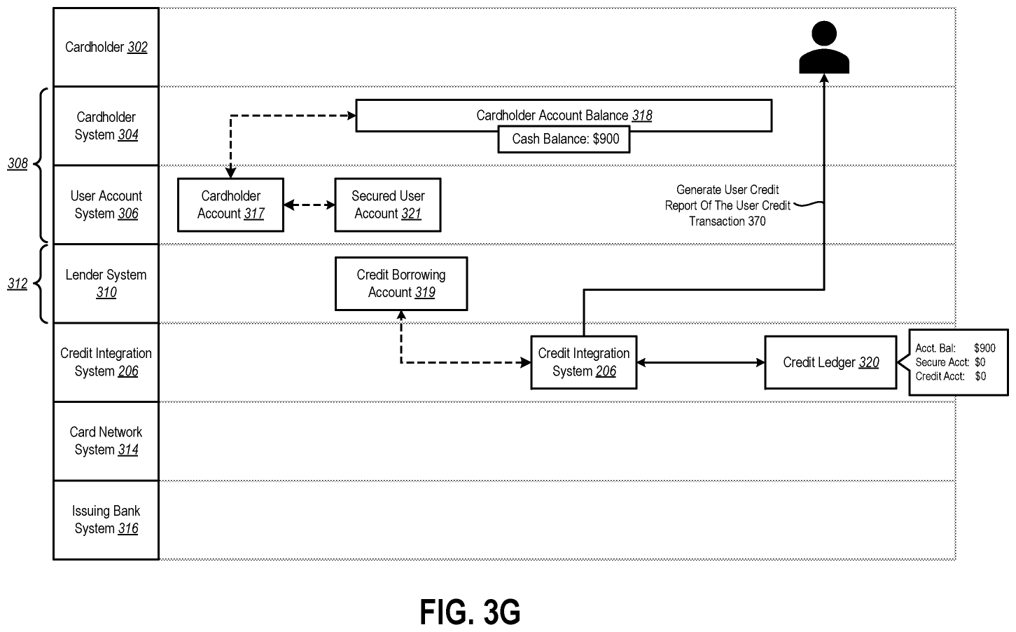

Additional details regarding an example implementation of the credit integration system will be discussed in connection with the following figures. To illustrate, FIG. 1 provides an example overview of generating credit-based transactions from non-credit-based transactions according to one or more implementations. As shown, FIG. 1 includes a series of acts 100 that are primarily performed by a credit integration system. While FIG. 1 provides a general overview of the credit integration system generating credit-based transactions for a user (e.g., cardholder) from non-credit-based transactions, FIG. 3A-3G provide more specific details.

The series of acts 100, as shown, includes an act 102 of migrating the target amount of funds from a user account to a secured user account after detecting a user transaction for the target amount. For instance, a non-credit-based system maintains non-credit-based accounts (i.e., user accounts) for users to store deposited funds (i.e., user account funds). The non-credit-based system also provides a computing network that allows users to digitally access their user account funds using a non-credit payment card (e.g., a debit or prepaid card). For example, the cardholder (e.g., the user with a non-credit payment card) transacts with merchants to purchase goods or services.

When a cardholder transacts with their non-credit-based payment card for a target amount (e.g., the transaction amount), the non-credit-based system receives a notification of the transaction. In response, as shown in the act 102, the non-credit-based system (e.g., bank) migrates the target amount of funds from the user account to a separate secured user account that is not accessible to the user. In various implementations, the credit integration system causes (e.g., instructs or directs) the non-credit-based system to migrate the target amount of funds to the secured user account.

In various implementations, the credit integration system maintains a credit ledger, which includes user balances of users across non-credit-based systems and credit-based systems. For example, the credit ledger tracks a user's account balance and their secured user account balance from the non-credit-based system. The credit ledger also tracks the user's credit account balance from a credit-based system. As shown in connection with the act 102, the credit ledger for the example user includes $900 in their user account after moving $100 into their secured user account. The user's credit account is currently at $0 and will be further discussed next. Additional details regarding migrating funds from a user account to a secured user account are provided below in connection with FIGS. 3A-3D.

As shown, the series of acts 100 includes an act 104 of automatically securing the target amount of credit for the user from a credit lender. In various implementations, the credit integration system generates, or causes the non-credit-based system to generate, a user credit transaction for the user that secures credit for the user in the target amount from a lender system. For instance, the credit integration system and/or the non-credit-based system coordinate with a lender system to secure credit (e.g., a credit borrowing account) for one or more users. Then, as cardholder transactions are detected for target amounts, credit is secured for the target amount for corresponding users.

As shown, the credit ledger in the act 104 includes a balance of $900 in the user account and $100 in the secured user account as before. Additionally, the credit ledger shows a user credit balance of −$100 indicating that the user has borrowed or has a loan of credit for $100. Additional details regarding generating user credit transactions on behalf of users are provided below in connection with FIGS. 3B-3E.

As depicted, the series of acts 100 includes an act 106 of automatically transferring the target amount from the secured user account to the credit lender. For example, as part of a settlement, the non-credit-based system repays the credit-based system for the cardholder's loan with their funds stored in the secured user account. In one or more implementations, the credit integration system causes the non-credit-based system to transfer the target amount from the secured user account to the credit borrowing account of the credit-based system to repay the user credit transaction that extended credit for the target amount making the credit borrowing account whole.

To illustrate, the credit ledger in the act 106 shows a balance of $900 in the user account. The previous $100 in the secured user account has been transferred to the credit-based system causing the previous user credit balance of −$100 to reset to $0. Additional details regarding transferring funds from secured user accounts to a credit borrowing account are provided below in connection with FIGS. 3D-3F.

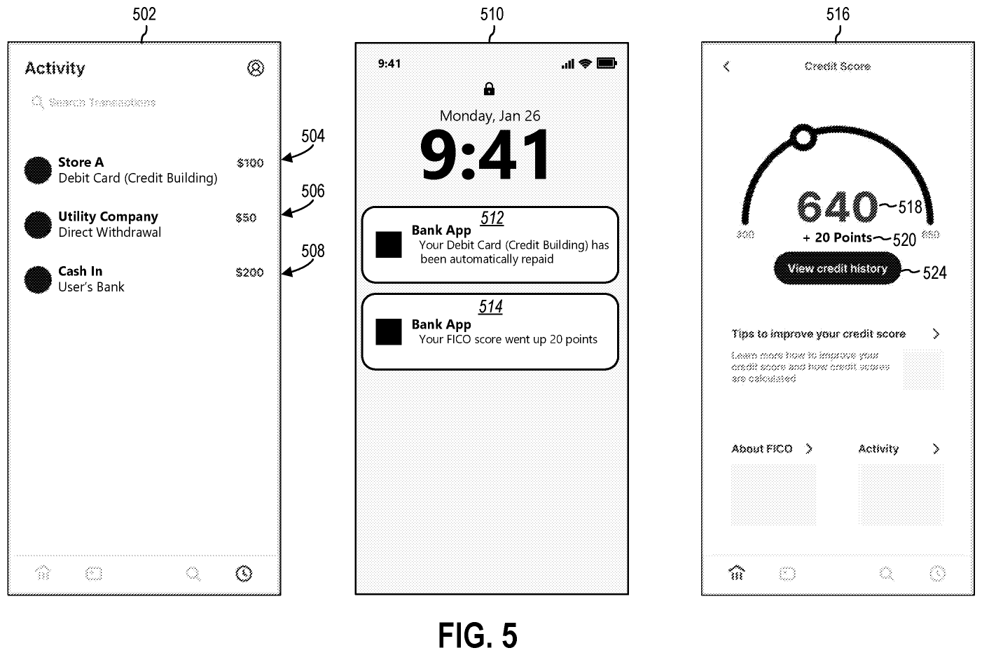

FIG. 1 also shows that the series of acts 100 includes an act 108 of generating and providing a user credit report for the user credit transaction. In various implementations, the credit integration system generates or causes the credit-based system to generate a user credit report for the user that includes the loan of credit (e.g., user credit transaction) and repayment of the target amount. The user credit report can then be provided or reported to a credit bureau. Additional details regarding generating and providing user credit reports are provided below in connection with FIG. 3G and FIG. 5.

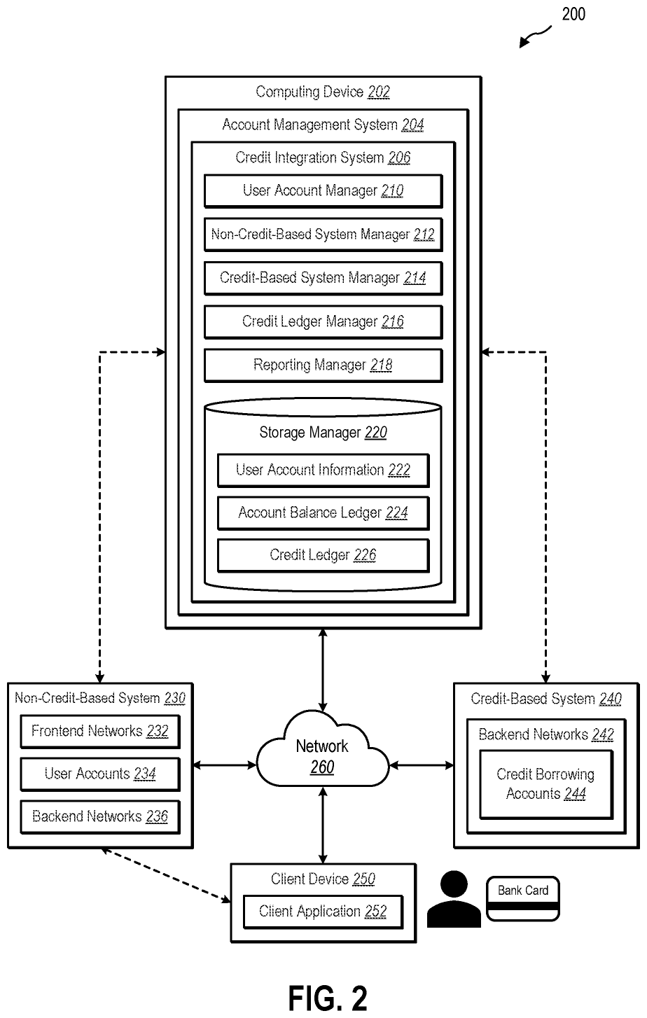

With a general overview of the credit integration system in place, additional details are provided regarding the components and elements of the credit integration system. To illustrate, FIG. 2 illustrates an example system environment where a credit integration system is implemented to build user credit from non-credit-based transactions according to one or more implementations. While FIG. 2 shows example arrangements and configurations with respect to various systems including the credit integration system, other arrangements and configurations are possible.

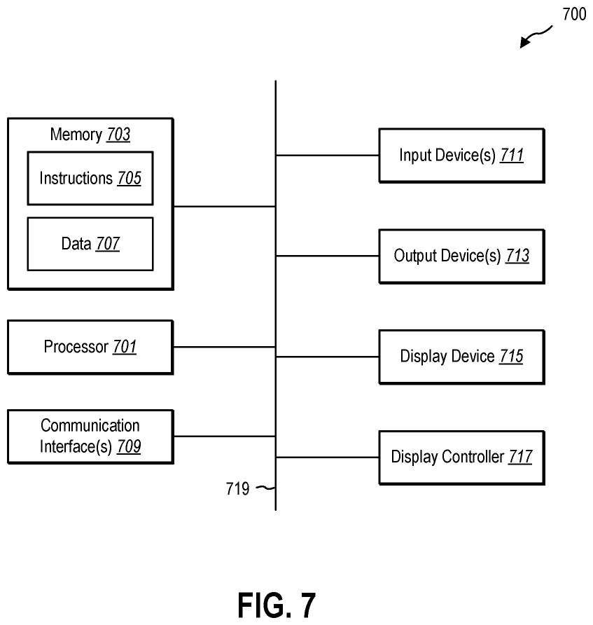

As shown in FIG. 2, there is a computing environment 200 having a computing device 202, a non-credit-based system 230, a credit-based system 240, and a client device 250, which are connected by at least a network 260. Further details regarding computing devices and computing systems are provided below in connection with FIG. 7. In addition, FIG. 7 also provides additional details regarding networks, such as the network 260 shown.

As shown, the computing environment 200 includes the computing device 202, which includes an account management system 204 and the credit integration system 206. In various implementations, the account management system 204 facilitates communications and transactions between various financial systems for several user accounts. In some instances, the account management system 204 manages payment cards and digital wallets to facilitate financial transactions.

As shown, the account management system 204 includes the credit integration system 206, which may be located inside or outside of the account management system 204. Additional details and components of the credit integration system 206 are provided shortly below after introducing the other elements in the computing environment 200.

As shown, the computing environment 200 includes the non-credit-based system 230. As mentioned, the non-credit-based system 230 includes computing devices and components for facilitating non-credit-based financial interactions. As shown, the non-credit-based system 230 includes frontend networks 232, user accounts 234, and backend networks 236. For example, the frontend networks 232 include computing devices and components (e.g., server-side infrastructure and software) that provide user interfaces to the user for depositing, accessing, and managing their user accounts at the non-credit-based system 230. For example, the frontend networks 232 provide a user interface for users to access via client applications on their client devices, as provided below.

In some implementations, the user accounts 234 include user accounts where a user's deposited funds (e.g., a cash balance) are directly accessible by the user (e.g., the cardholder). The user accounts 234 also include secured user accounts that store user funds on behalf of the user, which are not directly accessible by the user. As described in this document, the secured user account for a user is often funded by the non-credit-based system 230 transferring some or all of the funds in a user account based on directions from the credit integration system 206.

The non-credit-based system 230 also includes the backend networks 236 for handling the processing of financial transactions and communicating with other systems beyond the view of users. Among various implementations, the backend networks 236 include computing devices and components (e.g., server-side infrastructure and software) for sending funds of a user to a merchant system or the credit-based system 240 when authorized.

As shown, the computing environment 200 also includes the credit-based system 240. As mentioned, the credit-based system 240 includes computing devices and components (e.g., server-side infrastructure and software) that facilitate credit-based financial interactions to provide credit-based services such as extending, securing, borrowing, and lending credit. As shown, the credit-based system 240 includes backend networks 242 that manage credit borrowing accounts 244. As described below, in various implementations, the credit borrowing accounts 244 are extended to a non-credit-based system for borrowing funds on credit for cardholders of the non-credit-based system.

Notably, the credit-based system 240 lacks a frontend network as the credit integration system 206 integrates the functions of the credit-based system 240 into the non-credit-based system 230. For example, as described below, the credit integration system 206 embeds the backend networks 242 of the credit-based system 240 with the frontend networks 232 and the backend networks 236 of the non-credit-based system 230 to provide a seamless and efficient credit-building experience to cardholders of the non-credit-based system 230.

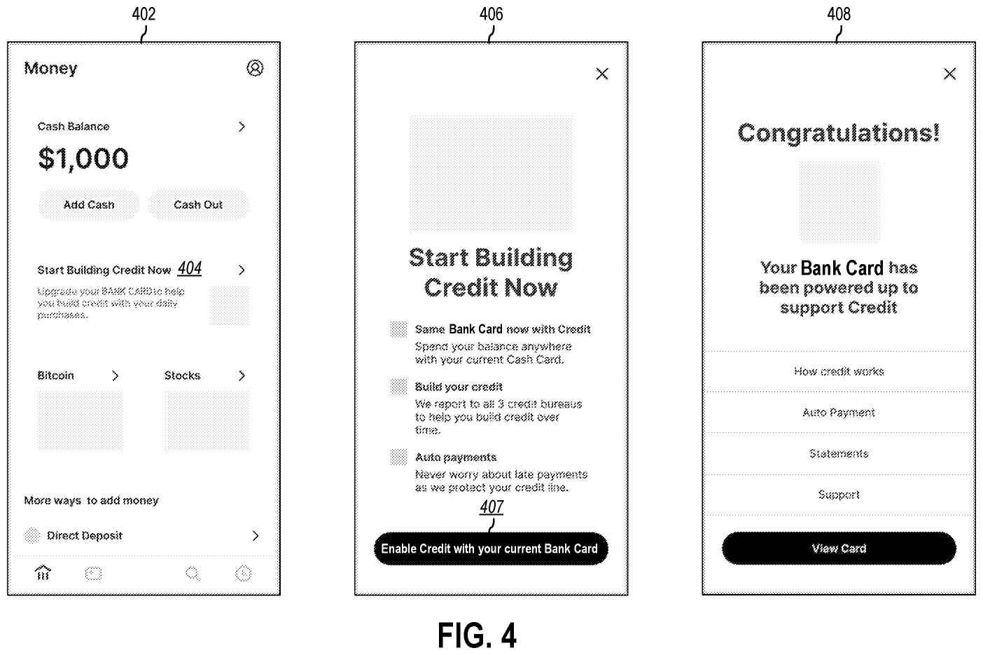

As shown, the computing environment 200 also includes the client device 250. In various implementations, the client device 250 is associated with a client device (e.g., a user of the non-credit-based system 230), such as a user who deposits funds in a non-credit-based system and uses a non-credit-based payment card to spend those funds. For example, the cardholder transacts with a merchant system (not shown) to purchase goods and services with their deposited funds using a debit card or prepaid payment card. In various implementations, the client device 250 is a computing device that allows the user to access and manage their funds via the non-credit-based system 230. For example, the client device 250 includes a client application 252, such as a web browser or mobile application that allows the cardholder to enable the features of the credit integration system 206. An example of a client device 250 is provided below in connection with FIG. 4 and FIG. 5.

As mentioned above, the credit integration system 206 includes various components and elements. As shown, the credit integration system 206 includes a user account manager 210 for managing information for users, such as user account information 222, an account balance ledger 224, and/or a credit ledger 226. In various implementations, the user account manager 210 maintains user account information 222 across different systems.

As shown, the credit integration system 206 includes a non-credit-based system manager 212 for managing interactions with and performing assorted actions of the non-credit-based system 230 as well as updating the user account information 222 and the account balance ledger 224. Similarly, the credit integration system 206 includes a credit-based system manager 214 for managing interactions between the credit-based system 240 and the non-credit-based system 230 as well as updating the user account information 222 and the credit ledger 226.

The credit integration system 206 also includes a credit ledger manager 216 that track and updates the credit ledger 226 when credit is extended to users and later repaid. Additionally, the credit integration system 206 includes a reporting manager 218, which generates and provides reports of user credit transactions and credit histories to one or more credit bureaus or other entities. Additionally, the credit integration system 206 includes a storage manager 220 for storing corresponding data and information, which includes the user account information 222, the account balance ledger 224, and the credit ledger 226.

As provided above, FIGS. 3A-3G provide additional details regarding the credit integration system 206 building credit for a cardholder based on non-credit-based transactions of the cardholder. In particular, FIGS. 3A-3G illustrate an example process of the credit integration system generating credit-based transactions from non-credit-based transactions by embedding a credit-based system within a non-credit-based system according to one or more implementations.

As shown, FIGS. 3A-3G depict a horizontal flow where the actions of various actors generally flow from left to right over time. In particular, the actors include (from top to bottom) a cardholder 302 such as a user, a cardholder system 304 such as a debit or prepaid payment card system, a user account system 306 such as a bank or financial institution that stores user deposits, a lender system 310 such as an extender of credit, the credit integration system 206, a card network system 314 such as settlement systems for processing a financial transaction between systems, and an issuing bank system 316 such as a guarantor of the user funds.

Additionally, as shown, the cardholder system 304 and the user account system 306 are part of the non-credit-based system 308 while the lender system 310 is part of the credit-based system 312. In some implementations, the non-credit-based system 308 and/or the lender system 310 includes different systems, elements, and components. Additional details will be provided in connection with FIGS. 3A-3G below.

While the credit integration system 206, the card network system 314, and the issuing bank system 316 are shown as separate systems, in some implementations, the credit integration system 206 includes the functions and features of the card network system 314 and/or issuing bank system 316. Likewise, in various implementations, the credit integration system 206 implements the functions of the cardholder system 304 and the user account system 306. In one or more implementations, the credit integration system 206 also performs the functions of the lender system 310. Indeed, depending on the implementation, the credit integration system 206 performs some or all of the functions of each actor shown in FIGS. 3A-3G except for the cardholder 302.

As shown in FIG. 3A, the user account system 306 accepts a deposit from the cardholder 302. For example, the cardholder 302 performs an act 330 of adding funds from an external user account 315 to the cardholder account 317 (e.g., a bank account or prepaid account) within the user account system 306. While funds generally come from an external user account, such as being paid by an employer or depositing a check or electronic funds from others, in some instances, the cardholder directly deposits cash into the cardholder account 317 with the user account system 306. In some implementations, the credit integration system 206 directs the user account system 306 to notify the cardholder system 304 of the updated balance in the cardholder account 317.

In various implementations, the cardholder system 304 communicates with the user account system 306 to allow the cardholder 302 (e.g., a user) to use a non-credit-based payment card to access funds of the cardholder stored with the user account system 306 as well as transact with external systems, such as a merchant system (not shown). To illustrate, in response to receiving the deposit into the cardholder account 317, FIG. 3A shows the user account system 306 performing an act 332 of updating the cardholder's account balance with the cardholder system 304. Additionally, the cardholder system 304 may send an update to the cardholder account balance ledger 318, which itself updates to reflect the new cash balance of the cardholder's updated balance.

Accordingly, in some implementations, upon the user account system 306 indicating the updated balance of the cardholder, the cardholder system 304 may update the cardholder account balance ledger 318 that it maintains to indicate the amount of funds that are available for the cardholder to spend when transacting with their non-credit-based payment card. In this example, FIG. 3A shows the cardholder account balance ledger 318 having a cash balance of $1000.

In FIG. 3B, the act 334 includes the user account system 306 obtaining credit for cardholders from the lender system 310. For example, the user account system 306 obtains a credit borrowing account 319 (e.g., a balance sheet account of $X in credit) that can be extended to one or more cardholders who have sufficient funds in their cardholder accounts. For instance, the funds provided in the credit borrowing account 319 match, approximate, or go up to a maximum limit that is less than the total amount of funds deposited by cardholders in the user account system 306. In some implementations, the credit integration system 206 directs the user account system 306 and/or the non-credit-based system 308 to obtain credit for cardholders from the lender system 310 and/or the credit-based system 312.

As shown, FIG. 3B also includes the acts 336a and 336b reporting that funds have been secured from the lender system 310 for cardholder transactions. For instance, the credit integration system causes the user account system 306 and/or the lender system 310 to report to the issuing bank system 316 (e.g., the act 336a) that the lender system 310 is providing funds from a credit borrowing account for cardholder transactions. In response, the issuing bank system 316 sets up a cardholder funding account 326 with the funds from the lender system 310. Additionally, the issuing bank system 316 reports that funds are secured for the cardholder transactions from the cardholder funding account 326 in the issuing bank system 316.

As mentioned above, conventional systems fund the cardholder funding account 326 and pay for user transactions directly from cardholder funds deposited in the cardholder accounts of the user account system 306. In contrast, the credit integration system 206 causes funds to be moved or transferred from a credit borrowing account 319 (e.g., a balance sheet account) of the lender system 310 to the cardholder funding account 326 to pay for cardholder transactions.

As also shown, FIG. 3B includes the credit integration system 206 creating or having a credit ledger 320. In various implementations, the credit ledger 320 tracks the transactions of cardholders between various systems, including the status of any loan or borrowed credit with cardholders. As shown, the credit ledger 320 includes an account balance of the cardholder at $1000 representing the amount of funds the cardholder has in their cardholder account and other account balances described below. In some instances, the credit integration system 206 utilizes the credit ledger 320 to determine what directions to provide to what systems and when. In various implementations, the credit ledger 320 is created for one or more cardholders, including the cardholder 302 in this example.

In several implementations, the user account system 306 generates a secured user account 321 for the cardholder. For example, in connection with borrowing credit from the lender system 310, the user account system 306 generates one or more secured user accounts for cardholders who have selectively enabled the credit integration system 206 to assist them in credit building. As noted above, a secured user account holds funds for a cardholder on their behalf but does not allow direct access to the funds. Rather, a secured user account holds funds for the cardholder in trust and uses those funds in the future to settle the debts of the cardholder (or return them to the cardholder if they choose to settle their debt another way). In some instances, a cardholder can request and receive access to the funds in their secured user account.

FIG. 3C shows an act 338 of the cardholder 302 transacting for a target amount of funds. For instance, the cardholder 302 purchases goods or services with their non-credit-based payment card tied to the user account system 306 for $100. Upon using the non-credit-based payment card, the card network 322 (e.g., the card network system 314) is notified of the transaction and provides indications to the credit integration system 206 and/or the user account system 306.

Additionally, the credit integration system 206 facilitates payment of the recent transaction with borrowed funds. To illustrate, FIG. 3C shows an act 342 of generating a user credit transaction from the credit borrowing account 319. For example, the user account system 306 directly or indirectly generates a user credit transaction (e.g., a loan or line of credit) from the credit borrowing account 319 provided by the lender system 310. As shown, the user credit transaction is provided to the cardholder funding account 326. In many implementations, the user credit transaction matches the target amount of the cardholder's transaction. In this way, the cardholder's transaction is being paid by credit rather than from the cardholder's funds for the cardholder account 317.

Additionally, in connection with the cardholder's payment card transaction, the credit integration system 206 performs an authorization and credit balance check of the cardholder's funds and credit. To illustrate, FIG. 3C includes an act 344 of the card network 322 sending an authorization message to the credit integration system 206 and an act 346 of the credit integration system 206 performing a credit balance check against the credit ledger 320. For example, the credit integration system 206 authorizes the user credit transaction for the target amount to be used for the cardholder transaction based on checking the available credit for the cardholder in the credit ledger 320. To further illustrate, upon detecting the cardholder transaction for $100, the credit integration system 206 updates the credit ledger 320 to show an account balance of $1000, a secured balance of $0, and a credit balance account of −$100, which is a result of the user credit transaction of $100 being authorized to cover the cardholder transaction.

As shown, the credit integration system 206 performs an act 350 of sending an authorization notification to the cardholder system 304 to update the cardholder account balance ledger 318. For example, the authorization notification indicates authorization of a transaction for the target amount and an updated account balance for the cardholder. In response, the cardholder system 304 updates the cash balance in the cardholder account balance ledger 318 to reflect the spent funds (e.g., $1000 minus-$100 in credit to pay for the $100 purchase equals a $900 cash balance), shown as the act 351. As depicted, the cash balance of the cardholder account balance ledger 318 changes from $1000 to $900 to reflect the recent transaction.

Additionally, the credit integration system 206 and/or other systems can perform treasury functions associated with a transaction and financial settlement. For example, the issuing bank system 316 moves the authorized funds from the cardholder funding account 326 to a cardholder account 328 to ensure the funds are available for settlement, as shown in the act 352.

At some point, the credit-based system 312 can initiate a settlement. FIG. 3D includes additional acts for performing settlement of the cardholder transaction (e.g., the process of transferring funds between the cardholder and the merchant system). To illustrate, FIG. 3D includes an act 354 of the card network 322 (e.g., the card network system 314) initiating settlement based on a network settlement account 324 and an act 356 of the card network 322 utilizing the issuing bank system 316 to perform settlement with the network settlement account 324, which can include paying the merchant system with the funds held in the cardholder account 328.

FIG. 3D also includes an act 358 of the card network 322 sending a clearing file to the credit integration system 206. For example, the card network 322 indicates to the credit integration system 206 that settlement has occurred. In response, the credit integration system 206 sends a clearing indication to update the credit ledger 320, as shown in the act 360. Additionally, the credit integration system 206 sends a clearing notification to the cardholder system 304 to update the cardholder account balance ledger 318, as shown in the act 362, to reflect that the transaction has been completed with the merchant system (e.g., change the $100 transaction from pending status to posted status).

In some implementations, after the cardholder transaction has cleared, the user account system 306 performs an act 340 of migrating the target amount of funds from the cardholder account 317 (e.g., bank account) to a secured user account 321. For example, the credit integration system 206 directs the user account system 306 to move funds from the cardholder account 317 to the secured user account 321 matching those of a detected payment card transaction (e.g., the target amount). In this example, the user account system 306 moves $100 from the cardholder account 317 to the secured user account 321. This way, as the cardholder spends their saved funds, matching funds are automatically moved from their cash balance to their secured holding account.

In some implementations, the credit integration system 206 does not wait for the transaction to clear but instead directs the user account system 306 to migrate or move the target amount from the cardholder account 317 to the secured user account 321 as soon as the cardholder transaction is detected (or move the funds under a pending status). For example, when the credit integration system 206 detect a transaction by the cardholder 302 for a target amount, the credit integration system 206 instructs or directs the user account system 306 to migrate, move, or transfer the funds to the secured user account 321. If the pending transaction does not clear, in these instances, the user account system 306 moves the target amount of funds back to the cardholder account 317 (or keeps the funds where they are an removes the pending status). Once the merchant system has been paid for the transactions from the cardholder's user credit transaction (e.g., line of credit), the credit integration system 206 causes the user account system 306 to migrate the target amount of funds to the secured user account 321 if it has not been done already.

Along with clearing the $100 transaction and migrating or transferring the target amount of funds to the secured user account 321, the credit integration system 206 updates the credit ledger 320. As shown in FIG. 3D, the credit ledger 320 includes an account balance of $900 (e.g., $1000-$100 in moved funds), a secured balance of $100 (e.g., the moved funds), and a credit balance of −$100.

At this point, the merchant system has been paid for the cardholder transaction from a user credit transaction (e.g., line of credit) automatically generated on behalf of the user for the target amount of funds. Further, the target amount of funds has been moved from deposited funds in the cardholder account 317 to the secured user account 321 where the user cannot access them. Further, the cash balance in the cardholder account balance ledger 318 reflects that the target amount of funds has been spent and is no longer directly accessible to the user. However, the user credit transaction still needs to be settled, which will be discussed next.

FIG. 3E provides a first approach for automatically repaying the user credit transaction of the cardholder while FIG. 3F provides a second approach that allows for manual repayment. While automatic settlement is preferred and improves efficiency, regulations require the cardholder to have the option to not repay borrowed credit or delay repayment. Accordingly, the manual repayment approach provides cardholders with the option to manually settle the user credit transaction.

To illustrate, FIG. 3E shows what happens when the cardholder enables automatic, behind-the-scenes, repayment of user credit transactions when utilizing the features and benefits of the credit integration system 206. In various implementations, the automatic repayment of the user credit transactions occurs on or after a period elapses, such as a due date or due date range, which is often regulated by waiting for a minimum number of days to allow borrowers to repay borrowed credit. Accordingly, in many implementations, the credit integration system 206 initiates the automatic repayment process when appropriate. To illustrate, FIG. 3E shows the cardholder account balance ledger 318 performing the act 368 of initiating credit repayment.

In various implementations, the credit integration system 206 repays the funds borrowed for the cardholder (e.g., the user credit transaction) indirectly from the cardholder account 317 using the secured user account 321. To illustrate, FIG. 3E includes an act 366 of transferring funds from the secured user account 321 to the credit borrowing account 319 of the lender system 310. In particular, the credit integration system 206 directs the user account system 306 to move the target amount of funds from the secured user account 321 to the secured user account 321 of the lender system 310 to repay the user credit transaction and make the secured user account 321 empty (e.g., zero dollars if not no other account activity). In most cases, the user credit transaction is repaid without a fee or interest being charged to the cardholder because of the automatic timely repayment.

To further illustrate, the credit borrowing account 319 includes a credit balance of $X. If the user credit transaction is for a target amount of $100, then the credit borrowing account 319 sits at $X-$100 until it is repaid or is made whole. Accordingly, when the funds from the secured user account 321 are transferred to the lender system 310, the credit borrowing account 319 returns to a credit balance of $X.

Additionally, in connection with making the credit borrowing account 319 whole, the credit integration system 206 also updates the credit ledger 320 to reflect the repayment. For example, upon repayment, the credit integration system 206 changes the balances in the credit ledger 320 from a pending set of balances (e.g., an account balance of $900, a secured user account balance of $100, and a credit balance of −$100) to an updated set of balances (e.g., an account balance of $900, a secured user account balance of $0, and a credit balance of $0). Upon updating the credit ledger 320, in some instances, the credit integration system 206 communicates the repayment of the user credit transaction to the cardholder account balance ledger 318.

Moreover, unlike some conventional credit-based systems where a line of credit needs to be fully secured beforehand with a cash deposit that is tied up, the credit integration system 206 generates user credit transactions (e.g., loans) based on funds to which a cardholder currently has direct access, and funds are only tied up to secure borrowed credit as the cardholder spends them. In many instances, the credit integration system 206 utilizes real-time securitization to generate loans for a cardholder up to a limit, which may equal the total amount of deposit funds currently in their cardholder account.

FIG. 3F occurs when the cardholder does not enable automatic repayment of user credit transactions when utilizing the features and benefits of the credit integration system 206. For example, the cardholder opts into the features and benefits of the credit integration system 206 but does not opt-in to automatic repayment. In some implementations, the cardholder chooses not to have funds migrated to the secured user account 321, as described above. In some implementations, the cardholder chooses to make the secured user account 321 a secondary user account that functions the same as the secured user account 321 described above, but that is also directly accessible (e.g., the cardholder manually repays the user credit transaction from the secondary user account).

As shown in FIG. 3F, the user chooses to repay the user credit transaction with external funds rather than with the funds in the secured user account 321. To illustrate, FIG. 3F also includes the act 368 of initiating credit repayment as before. Additionally, FIG. 3F includes an act 367 of providing external funds. In particular, the lender system 310 receives the target amount of funds for the credit borrowing account 319 to repay the user credit transaction. For example, the cardholder 302 provides $100 from an external user account 315 to repay the loan (i.e., user credit transaction).

In these instances, because the user credit transaction is repaid, the user account system 306 returns the target amount of funds in the secured user account 321 back to the cardholder account 317, as shown in the act 369. In some implementations, the user account system 306 makes the target amount of funds in the secured user account 321 accessible to the cardholder 302 upon the user credit transaction being repaid with external funds.

As before, in connection with making the credit borrowing account 319 whole, the credit integration system 206 updates the credit ledger 320 to reflect the repayment. For example, upon repayment, the credit integration system 206 changes the balances in the credit ledger 320 from a pending set of balances (e.g., an account balance of $900, a secured user account balance of $100, and a credit balance of −$100) to an updated set of balances (e.g., an account balance of $1000, a secured user account balance of $0, and a credit balance of $0). Note, the account balance of $1000 reflects the $100 from the secured user account 321 being returned to the cardholder account 317 as it is not used to repay the $100 loan. Also, in some instances, upon updating the credit ledger 320, the credit integration system 206 communicates repayment of the user credit transaction to the cardholder account balance ledger 318.

FIG. 3G corresponds to reporting the cardholder's credit transactions. For example, FIG. 3G includes an act 370 of generating a user credit report of the user credit transaction. For example, the credit integration system 206 generates or directs another system to generate a user credit report that shows the cardholder borrowing the user credit transaction and repaying it on time. In some implementations, a user credit report is generated each billing cycle by the lender system 310 and includes the user credit transaction of the cardholder 302.

In various implementations, the user credit report is provided to one or more credit bureaus that collect credit transactions of the cardholder. In this way, the credit integration system 206 enables the cardholder to get their transactions, trade lines, and payment history reported without the additional issues that a separate credit-based payment card has of securing or locking up funds to protect against loss for borrowed credit.

While FIGS. 3A-3F provide examples of the credit integration system 206 converting a single non-credit-based transaction into a credit-based transaction, the credit integration system 206 can repeat the process any number of times for any number of transactions up to the amount of funds a cardholder has in their cardholder account (or up to a limit). In some implementations, the credit integration system 206 groups several smaller transactions together before generating a user credit transaction (e.g., loan or line of credit), such as when the user credit transaction requires a minimum amount to qualify for a loan.

Turning to the following figures, FIG. 4 and FIG. 5 provide visual examples corresponding to implementations of the credit integration system 206. In FIG. 4 and FIG. 5, the depicted user interfaces may be displayed on a client device, such as the client device 250 associated with a cardholder, as described above. For example, the user interfaces are part of a client application 252 provided by the credit integration system 206, a cardholder system, and/or a user account system. In many instances, the user interfaces are provided by frontend networks of a non-credit-based system (e.g., a bank's webpage or application) rather than the frontend of a credit-based system.

As illustrated, FIG. 4 shows an example user interface process for selectively enabling features of the credit-based system according to one or more implementations. As illustrated in FIG. 4, there are three user interfaces with which a cardholder may interact. For instance, the first user interface 402 shows a home or landing screen that provides information to the cardholder, such as the cardholder's current account balance (e.g., cash balance) and features provided by the non-credit-based system.

Additionally, the first user interface 402 includes a menu option 404 for enabling the credit building feature of the credit integration system 206. Upon detecting the selection of the menu option 404, the user interface may update to a new screen showing more information regarding the credit integration system 206. For instance, upon detecting the selection of the menu option 404, the non-credit-based system updates the display of the client device to show a second user interface 406.

As shown in the second user interface 406, there is additional information about the credit building functions and features of the credit integration system 206, which seamlessly build the credit history of the cardholder without requiring a new payment card or the cardholder to change their current behaviors with their current non-credit-based payment card. Additionally, the second user interface 406 may provide additional information regarding automatic payments. As shown, the second user interface 406 includes a selectable option 407 to enable the credit integration system.

Upon detecting the selection of the selectable option 407, as shown, the non-credit-based system updates the display of the client device to show a third user interface 408. As shown, the third user interface 408 includes a confirmation of the cardholder enabling the functions and features of the credit integration system.

As mentioned above, in one or more implementations, the frontend network of a non-credit-based system provides the second user interface 406. However, the credit offered to the cardholder is from a credit-based system. Accordingly, in several implementations, the credit integration system 206 facilitates elements of the credit-based system being visually embedded with those of the non-credit-based system, as shown. In this way, the credit-based system does not need to maintain its own set of frontend networks while the backend networks still operate to offer, provide, and track credit-based funds.

In addition, the third user interface 408 also includes various menu options that include links to additional information about the credit integration system, tools for managing settings, and links to support. For example, the third user interface 408 includes a tool for viewing and modifying the automatic payment settings, such as toggling it on/off or repaying user credit transactions with an external user account 315. As another example, the third user interface 408 includes statements, such as previous or pending user credit reports of user credit transactions reflecting the cardholder's borrowing history. In various instances, the third user interface 408 includes additional menu options corresponding to the client devices.

FIG. 5 illustrates example user interfaces of the credit integration system providing credit indications to a user based on the user performing non-credit-based transactions according to one or more implementations. As shown, FIG. 5 includes three additional user interfaces corresponding to the credit integration system. In various implementations, the non-credit-based system generates the user interfaces on a client device in connection with directions provided by the credit integration system 206.

As shown, the first user interface 502 shows recent cardholder account activity, which can include pending and posted transactions. For example, the list of activities includes a first activity 504 of $100 where the cardholder spent $100 from Store A using their non-credit-based payment card having credit building enabled. For this transaction, the credit integration system 206 will use a loan to pay Store A and repay the loan with funds from the cardholder's account, as described above, thus building the cardholder's credit history. In some implementations, selecting the first activity 504 provides additional information to the cardholder, such as details and status updates regarding the user credit transaction associated with the transaction.

The activity list may include additional items, such as a second activity 506 of a direct withdrawal to pay a bill. In some instances, the credit integration system 206 may also work with withdrawals and electronic transfers, where borrowed credit is first used to pay out funds and the credit is repaid with the funds in the cardholder's account rather than directly paying out funds from the cardholder's account. As also shown, the activity list may include deposits that increase the balance of the account, such as the third activity 508. By providing an activity list, the credit integration system 206 can keep the user apprised of current and outstanding credit transactions.

As mentioned above, in some implementations, one or more items in the activity list are based on updates received from the credit ledger of the credit integration system 206. For example, upon updating the credit ledger in response to transactions with the payment card, the credit integration system 206 provides indications to update the cardholder account balance ledger, upon which one or more of the items in the activity list are based.

The credit integration system 206 can also notify the cardholder with status updates of a user credit transaction. For example, the second user interface 510 shows a first notification 512 indicating that the credit integration system 206 has automatically repaid the user credit transaction from the payment card to build up credit. In some instances, the credit integration system 206 notifies the cardholder when a user credit transaction is secured and credit is borrowed.

As another example, the second user interface 510 shows a second notification 514 indicating that the cardholder's credit score has increased. Similarly, as shown in the third user interface 516, the credit integration system 206, directly or via the non-credit-based system, provides the cardholder with their credit score 518, recent credit score changes 520, and their credit history 524, which includes user credit transactions automatically generated, repaid, and reported by the credit integration system 206.

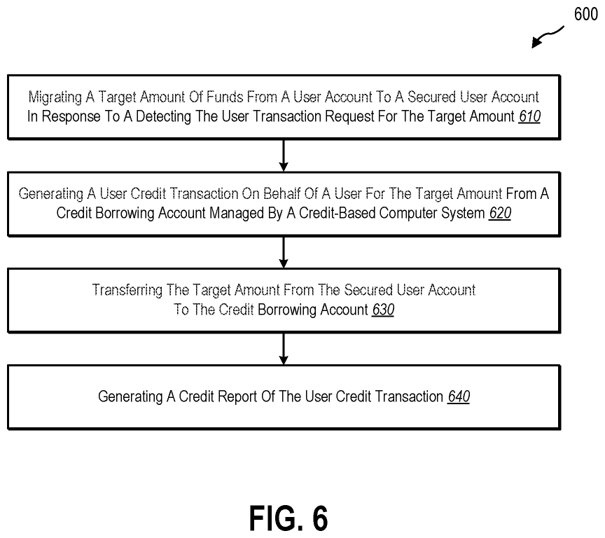

Turning now to FIG. 6, this figure illustrates an example flowchart that includes a series of acts 600 for utilizing the credit integration system 206 according to one or more implementations. In particular, FIG. 6 illustrates an example series of acts (as part of a computer-implemented method) for generating user credit history based on non-credit-based transactions.

While FIG. 6 illustrates acts according to one or more implementations, alternative implementations may omit, add, reorder, and/or modify any of the acts shown. Further, the acts of FIG. 6 can be performed as part of a method such as a computer-implemented method. Alternatively, a non-transitory computer-readable medium can include instructions that, when executed by a processing system comprising a processor, cause a computing device to perform the acts of FIG. 6. In still further implementations, a system can perform (e.g., a processing system with a processor can cause instructions to be performed) the acts of FIG. 6.

In one or more implementations, the series of acts 600 includes a system that includes various components. In some instances, the system includes a processing system and computer memory having instructions that, when executed by the processing system, cause the processing system to perform operations. In various implementations, the series of acts 600 includes acts performed by the credit integration system and/or one or more systems (e.g., a non-credit-based system or credit-based system) directed by the credit integration system.

As shown, the series of acts 600 includes an act 610 of migrating a target amount of funds from a user account to a secured user account in response to detecting the user transaction request for the target amount. For example, the act 610 involves, in response to detecting the user transaction request for the target amount at the non-credit-based computer system, causing or instructing the non-credit-based computer system to migrate or transfer the target amount of funds from the first user account to a second secured user account of the non-credit-based computer system, where the secured user account is not user-accessible.

In one or more implementations, the act 610 includes migrating, in response to or upon detecting a user transaction request for a target amount corresponding to user account funds in a first user account of a user, the target amount of funds from the first user account to a second secured user account, the second secured user account not being accessible by the user. In various implementations, the act 610 includes a credit integration system causing or instructing a non-credit-based computer system to migrate, in response to identifying a user transaction request for a target amount of user account funds in a first user account, the target amount of funds from the first user account to a second secured user account, the second secured user account being not user-accessible and managed by the non-credit-based computer system.

In some implementations, the act 610 includes migrating the target amount of funds from the first user account to the second secured user account. In one or more implementations, the act 610 includes detecting the user transaction request for a target amount and/or determining a user transaction request for a target amount of user account funds in a first user account that is managed by a non-credit-based computer system.

As further shown, the series of acts 600 includes an act 620 of generating a user credit transaction on behalf of a user for the target amount from a credit borrowing account managed by a credit-based computer system. For instance, in example implementations, the act 620 involves, based on migrating the target amount of funds to the second secured user account, causing a credit-based computer system to generate a user credit transaction on behalf of a user for the target amount from a credit borrowing account.

In one or more implementations, the act 620 includes generating a user credit transaction from a credit borrowing account for the target amount in response to detecting a user transaction request for a target amount corresponding to user account funds in a first user account of a user. In some implementations, the act 620 includes causing a credit-based computer system to generate the user credit transaction from the credit borrowing account for the target amount. In various implementations, the act 620 includes a credit integration system causing a credit-based computer system to generate a user credit transaction on behalf of a user for the target amount from a credit borrowing account in connection with migrating the target amount of funds to the second secured user account of the non-credit-based computer system.

In some instances, the act 620 includes providing the user credit transaction to the user in connection with a transaction with a non-credit-based electronic payment card provided by the non-credit-based computer system. In various instances, the act 620 includes providing the user credit transaction to the user in connection with a transaction with a credit-based electronic payment card (e.g., a credit card) provided by the non-credit-based computer system and/or a credit-based computer system. In various instances, the act 620 also includes providing the user credit transaction to the user without providing a credit-based payment card from either the non-credit-based computer system or the credit-based computer system.

In various implementations, the act 620 includes authorizing the user credit transaction on behalf of the user for the target amount based on an amount of the user account funds in the first user account in response to the user transaction request and storing an authorized amount of user credit transactions of the user in a credit ledger associated with the user. In some instances, the act 620 includes maintaining a credit ledger that tracks and updates amounts within the first user account, the second secured user account, and the credit borrowing account. In various instances, the credit borrowing account includes a balance sheet account, and/or the user credit transaction corresponds to a line of credit extended to the user from the balance sheet account for the target amount of funds.

As further shown, the series of acts 600 includes an act 630 of transferring the target amount from the secured user account to the credit borrowing account. For instance, in example implementations, the act 630 involves causing the non-credit-based computer system to transfer the target amount from the second secured user account to the credit borrowing account of the credit-based computer system to update the user credit transaction.

In one or more implementations, the act 630 includes transferring the target amount from the second secured user account to the credit borrowing account to update the user credit transaction. In some implementations, the act 630 includes transferring the target amount from the second secured user account to the credit borrowing account to update the user credit transaction. In various implementations, the act 630 includes a credit integration system causing the non-credit-based computer system to transfer the target amount from the second secured user account to the credit borrowing account of the credit-based computer system to update the user credit transaction upon a time period elapsing

In various implementations, the act 620 includes updating the credit ledger based on transferring the target amount from the second secured user account to the credit borrowing account to indicate that the user credit transaction is repaid or paid off and/or the second secured user account is empty (e.g., returns to zero). In several implementations, the act 630 includes causing a credit-based computer system to complete the user credit transaction upon receiving the target amount from the second secured user account.

As further shown, the series of acts 600 includes an act 640 of generating a credit report of the user credit transaction. For instance, in example implementations, the act 640 involves generating and providing a user credit report of the user credit transaction of the credit borrowing account.

In one or more implementations, the act 640 includes generating and providing a user credit report of the user credit transaction of the credit borrowing account. In various implementations, the act 640 includes a credit integration system causing the credit integration system to provide a user credit report of the user credit transaction of the credit borrowing account. In various implementations, the act 640 includes generating the user credit report to include a repayment history of the user credit transaction with the credit borrowing account and providing the user credit report to a credit bureau.

In some implementations, the series of acts 600 includes additional acts. For example, in various instances, the user account funds in the first user account are maintained by the non-credit-based computer system. In some cases, neither the non-credit-based computer system nor the credit-based computer system provides the user with a credit-based electronic payment card to access the credit borrowing account. In various instances, the credit integration system includes the non-credit-based computer system or the credit-based computer system.

In some implementations, the credit-based system lacks a frontend network and/or the credit-based computer system causes a selectable option to be provided by a frontend network of the non-credit-based computer system within a user interface. In some implementations, a backend network of the credit-based computer system interacts with the frontend network of the non-credit-based computer system and a backend network of the non-credit-based computer system. In one or more implementations, the selectable option included in the user interface provided by the frontend network of the non-credit-based computer system selectively enables the credit integration system to cause the credit-based computer system to automatically generate user credit transactions on behalf of the user without user interaction with the credit-based computer system.

In one or more implementations, the non-credit-based computer system facilitates transacting funds previously provided to the non-credit-based computer system, the credit-based computer system facilitates transacting borrowed funds not previously provided to the non-credit-based computer system, and/or the non-credit-based computer system is separate from the credit-based computer system. In various implementations, the non-credit-based computer system includes a user account network that maintains the first user account and the second secured user account and/or a card balance ledger network that provides a user interface corresponding to a prepaid or debit electronic payment card connected to the user account funds in the first user account.

FIG. 7 illustrates certain components that may be included within a computer system 700. The computer system 700 may be used to implement the various computing devices, components, and systems described herein (e.g., by performing computer-implemented instructions). As used herein, a “computing device” refers to electronic components that perform a set of operations based on a set of programmed instructions. Computing devices include groups of electronic components, client devices, server devices, etc.

In various implementations, the computer system 700 represents one or more of the client devices, server devices, or other computing devices described above. For example, the computer system 700 may refer to various types of network devices capable of accessing data on a network, a cloud computing system, or another system. For instance, a client device may refer to a mobile device such as a mobile telephone, a smartphone, a personal digital assistant (PDA), a tablet, a laptop, or a wearable computing device (e.g., a headset or smartwatch). A client device may also refer to a non-mobile device such as a desktop computer, a server node (e.g., from another cloud computing system), or another non-portable device.

The computer system 700 includes a processing system including a processor 701. The processor 701 may be a general-purpose single- or multi-chip microprocessor (e.g., an Advanced Reduced Instruction Set Computer (RISC) Machine (ARM)), a special-purpose microprocessor (e.g., a digital signal processor (DSP)), a microcontroller, a programmable gate array, etc. The processor 701 may be referred to as a central processing unit (CPU) and may cause computer-implemented instructions to be performed. Although the processor 701 shown is just a single processor in the computer system 700 of FIG. 7, in an alternative configuration, a combination of processors (e.g., an ARM and DSP) could be used.

The computer system 700 also includes memory 703 in electronic communication with the processor 701. The memory 703 may be any electronic component capable of storing electronic information. For example, the memory 703 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM), registers, and so forth, including combinations thereof.

The instructions 705 and the data 707 may be stored in the memory 703. The instructions 705 may be executable by the processor 701 to implement some or all of the functionality disclosed herein. Executing the instructions 705 may involve the use of the data 707 that is stored in the memory 703. Any of the various examples of modules and components described herein may be implemented, partially or wholly, as instructions 705 stored in memory 703 and executed by the processor 701. Any of the various examples of data described herein may be among the data 707 that is stored in memory 703 and used during the execution of the instructions 705 by the processor 701.

A computer system 700 may also include one or more communication interface(s) 709 for communicating with other electronic devices. The one or more communication interface(s) 709 may be based on wired communication technology, wireless communication technology, or both. Some examples of the one or more communication interface(s) 709 include a Universal Serial Bus (USB), an Ethernet adapter, a wireless adapter that operates according to an Institute of Electrical and Electronics Engineers (IEEE) 702.11 wireless communication protocol, a Bluetooth® wireless communication adapter, and an infrared (IR) communication port.

A computer system 700 may also include one or more input device(s) 711 and one or more output device(s) 713. Some examples of the one or more input device(s) 711 include a keyboard, mouse, microphone, remote control device, button, joystick, trackball, touchpad, and light pen. Some examples of the one or more output device(s) 713 include a speaker and a printer. A specific type of output device that is typically included in a computer system 700 is a display device 715. The display device 715 used with implementations disclosed herein may utilize any suitable image projection technology, such as liquid crystal display (LCD), light-emitting diode (LED), gas plasma, electroluminescence, or the like. A display controller 717 may also be provided, for converting data 707 stored in the memory 703 into text, graphics, and/or moving images (as appropriate) shown on the display device 715.

The various components of the computer system 700 may be coupled together by one or more buses, which may include a power bus, a control signal bus, a status signal bus, a data bus, etc. For clarity, the various buses are illustrated in FIG. 7 as a bus system 719.

In addition, the network described herein may represent a network or a combination of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which one or more computing devices may access the credit integration system. Indeed, the networks described herein may include one or multiple networks that use one or more communication platforms or technologies for transmitting data. For example, a network may include the Internet or other data link that enables transporting electronic data between respective client devices and components (e.g., server devices and/or virtual machines thereon) of the cloud computing system.

Further, upon reaching various computer system components, program code means in the form of computer-executable instructions or data structures can be transferred automatically from transmission media to non-transitory computer-readable storage media (devices), or vice versa. For example, computer-executable instructions or data structures received over a network or data link can be buffered in random-access memory (RAM) within a network interface module (NIC), and then it is eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions include instructions and data that, when executed by a processor, cause a general-purpose computer, special-purpose computer, or special-purpose processing device to perform a certain function or group of functions. In some implementations, computer-executable and/or computer-implemented instructions are executed by a general-purpose computer to turn the general-purpose computer into a special-purpose computer implementing elements of the disclosure. The computer-executable instructions may include, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or a combination of hardwired and wireless data links) through a network, both perform tasks. In a distributed system environment, program modules may be located in both local and remote memory storage devices.

The techniques described herein may be implemented in hardware, software, firmware, or any combination thereof unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium including instructions that, when executed by at least one processor, perform one or more of the methods described herein (including computer-implemented methods). The instructions may be organized into routines, programs, objects, components, data structures, etc., which may perform particular tasks and/or implement particular data types, and which may be combined or distributed as desired in various implementations.

Computer-readable media can be any available media that can be accessed by a general-purpose or special-purpose computer system. Computer-readable media that store computer-executable instructions are non-transitory computer-readable storage media (devices). Computer-readable media that carry computer-executable instructions are transmission media. Thus, by way of example, implementations of the disclosure can include at least two distinctly different kinds of computer-readable media: non-transitory computer-readable storage media (devices) and transmission media.

As used herein, non-transitory computer-readable storage media (devices) may include RAM, ROM, EEPROM, CD-ROM, solid-state drives (SSDs) (e.g., based on RAM), Flash memory, phase-change memory (PCM), other types of memory, other optical disk storage, magnetic disk storage or other magnetic storage devices, or any other medium which can be used to store desired program code means in the form of computer-executable instructions or data structures and which can be accessed by a general-purpose or special-purpose computer.

The steps and/or actions of the methods described herein may be interchanged with one another without departing from the scope of the claims. In other words, unless a specific order of steps or actions is required for the proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a data repository, or another data structure), ascertaining, and the like. Also, “determining” can include receiving (e.g., receiving information), accessing (e.g., accessing data in a memory), and the like. Also, “determining” can include resolving, selecting, choosing, establishing, and the like.

The terms “comprising,” “including,” and “having” are intended to be inclusive and mean that there may be additional elements other than the listed elements. Additionally, it should be understood that references to “one implementation” or “implementations” of the present disclosure are not intended to be interpreted as excluding the existence of additional implementations that also incorporate the recited features. For example, any element or feature described concerning an implementation herein may be combinable with any element or feature of any other implementation described herein, where compatible.

The present disclosure may be embodied in other specific forms without departing from its spirit or characteristics. The described implementations are to be considered illustrative and not restrictive. The scope of the disclosure is indicated by the appended claims rather than by the foregoing description. Changes that come within the meaning and range of equivalency of the claims are to be embraced within their scope.

1. A computer-implemented method implemented by one or more computing devices, the computer-implemented method comprising:
generating, by a frontend portion of a non-credit-based computer system and for display on a user device a user interface showing a current credit score of a user;
determining a user transaction request for a target amount of funds in a first non-credit-based user account of the user that is managed by the non-credit-based computer system;
causing a backend portion of the non-credit-based computer system lacking user interface functionality to migrate, in response to the user transaction request for the target amount of funds from the first non-credit-based user account associated with the user, the target amount of funds from the first non-credit-based user account to a second non-credit-based secured user account of the non-credit-based computer system, the second non-credit-based secured user account being user inaccessible and managed by the non-credit-based computer system;
causing a backend portion of a credit-based computer system embedded into the non-credit-based computer system to generate a user credit transaction at the credit-based computer system to obtain new credit on behalf of a user for the target amount of funds in connection with migrating the target amount of funds to the second non-credit-based secured user account of the non-credit-based computer system;
causing the backend portion of the non-credit-based computer system to transfer the target amount of funds from the second non-credit-based secured user account to the backend portion of the credit-based computer system embedded within the non-credit-based computer system to update the user credit transaction upon a time period elapsing; and
updating, by the frontend portion of the non-credit-based computer system and for display on the user device, the user interface to reflect an effect on the current credit score of the user resulting from transferring the target amount of funds from the second non-credit-based secured user account to the credit-based computer system.

2. The computer-implemented method of claim 1, further comprising causing the credit-based computer system to generate the user credit transaction for the user in connection with a transaction of the user transaction request being performed with a non-credit-based electronic payment card provided by the non-credit-based computer system.

3. The computer-implemented method of claim 2, further comprising causing the credit-based computer system to provide the user credit transaction to the user without providing a credit-based payment card from either the non-credit-based computer system or the credit-based computer system.

4. The computer-implemented method of claim 1, further comprising:
authorizing the user credit transaction to obtain the new credit on behalf of the user for the target amount of funds based on an amount of the funds in the first non-credit-based user account in response to the user transaction request; and
storing an authorized amount of user credit transactions of the user in a credit ledger associated with the user.

5. The computer-implemented method of claim 4, further comprising updating the credit ledger based on transferring the target amount of funds from the second non-credit-based secured user account to a credit borrowing account to indicate that:
the user credit transaction is repaid; and
the second non-credit-based secured user account is empty.

6. The computer-implemented method of claim 1, wherein the credit-based computer system:
lacks the frontend portion that provides user interfaces for facilitating user interactions with the credit-based computer system; and
causes a selectable option to be provided by the user interface of the frontend portion of the non-credit-based computer system.

7. The computer-implemented method of claim 6, wherein the backend portion of the credit-based computer system interacts with the frontend portion of the non-credit-based computer system and the backend portion of the non-credit-based computer system.

8. The computer-implemented method of claim 6, wherein the selectable option provided by the user interface of the frontend portion of the non-credit-based computer system selectively enables the one or more computing devices to cause the credit-based computer system to automatically generate user credit transactions to obtain the new credit on behalf of the user without user interaction with the credit-based computer system.

9. The computer-implemented method of claim 1, wherein the one or more computing devices include the non-credit-based computer system or the credit-based computer system.

10. The computer-implemented method of claim 1, wherein:
the non-credit-based computer system facilitates transacting funds previously provided to the non-credit-based computer system;
the credit-based computer system facilitates transacting borrowed funds not previously provided to the non-credit-based computer system; and
the non-credit-based computer system is separate from the credit-based computer system.

11. The computer-implemented method of claim 1, wherein the user credit transaction corresponds to a line of credit extended to the user from a balance sheet account for the target amount of funds.

12. The computer-implemented method of claim 1, wherein the non-credit-based computer system includes:
a user account network that maintains the first non-credit-based user account and the second non-credit-based secured user account; and
a card balance ledger network that provides a user interface corresponding to a prepaid or debit electronic payment card connected to the funds in the first non-credit-based user account.

13. The computer-implemented method of claim 1, further comprising:
generating and providing a user credit report of the user credit transaction of the credit-based computer system;
generating the user credit report to include a repayment history of the user credit transaction with the credit-based computer system, and
providing the user credit report to a credit bureau.

14. A credit integration computing system, comprising:
a processing system; and
computer memory having instructions that, when executed by the processing system, cause the processing system to perform operations comprising:
generating, for display on a user device, a user interface showing a current credit score of a user;
determining a user transaction request for a target amount of funds in a first non-credit-based user account of the user that is managed by a non-credit-based computer system;
in response to detecting the user transaction request for the target amount of funds corresponding to user account funds in the first non-credit-based user account of the user:
migrating the target amount of funds from the first non-credit-based user account to a second non-credit-based secured user account of the non-credit-based computer system, the second non-credit-based secured user account being inaccessible by the user; and
generating a user credit transaction from a credit borrowing account associated with multiple users for the target amount of funds to obtain new credit on behalf of the user for the target amount of funds at a credit-based computer system;
transferring the target amount of funds from the second non-credit-based secured user account of the non-credit-based computer system to the credit borrowing account of the credit-based computer system to update the user credit transaction; and
updating, for display on the user device, the user interface to reflect an effect on the current credit score of the user resulting from transferring the target amount of funds from the second non-credit-based secured user account to the credit-based computer system.

15. The credit integration computing system of claim 14, further comprising instructions that, when executed by the processing system, cause the processing system to perform additional operations comprising causing the non-credit-based computer system to:
detect the user transaction request for the target amount of funds;
migrate the target amount of funds from the first non-credit-based user account to the second non-credit-based secured user account; and
transfer the target amount of funds from the second non-credit-based secured user account to the credit borrowing account to update the user credit transaction.

16. The credit integration computing system of claim 14, further comprising instructions that, when executed by the processing system, cause the processing system to perform additional operations that comprise causing the credit-based computer system to:
generate the user credit transaction from the credit borrowing account for the target amount of funds; and
complete the user credit transaction upon receiving the target amount of funds from the second non-credit-based secured user account.

17. The credit integration computing system of claim 14, further comprising instructions that, when executed by the processing system, cause the processing system to perform additional operations that include maintaining a credit ledger that tracks and updates amounts within the first non-credit-based user account, the second non-credit-based secured user account, and the credit borrowing account.

18. A computer-implemented method, comprising:
generating, by a frontend portion of a non-credit-based computer system and for display on a user device, a user interface showing a current credit score of a user;
determining a user transaction request for a target amount of funds in a first non-credit-based user account of the user that is managed by the non-credit-based computer system;
in response to detecting the user transaction request for the target amount of funds at the non-credit-based computer system, causing a backend portion of the non-credit-based computer system lacking user interface functionality to migrate the target amount of funds from the first non-credit-based user account to a second non-credit-based secured user account of the non-credit-based computer system of the non-credit-based computer system, the second non-credit-based secured user account being inaccessible to a user;
based on migrating the target amount of funds to the second non-credit-based secured user account, causing a backend portion of a credit-based computer system embedded into the non-credit-based computer system to generate a user credit transaction to obtain new credit on behalf of the user for the target amount of funds at the credit-based computer system;
causing the backend portion of the non-credit-based computer system to transfer the target amount of funds from the second non-credit-based secured user account to the backend portion of the credit-based computer system to update the user credit transaction; and
updating, by the frontend portion of the non-credit-based computer system and for display on the user device, the user interface to reflect an effect on the current credit score of the user resulting from transferring the target amount of funds from the second non-credit-based secured user account to the credit-based computer system.

19. The computer-implemented method of claim 18, wherein neither the non-credit-based computer system nor the credit-based computer system provides the user with a credit-based electronic payment card to access the credit-based computer system.

20. The computer-implemented method of claim 18, wherein generating the user credit transaction to obtain the new credit on behalf of the user for the target amount of funds is based on the funds in the first non-credit-based user account maintained by the non-credit-based computer system.
